(19) United States
(12) Patent Application Publication
(10) Pub. No.: US 2011/0023812 A1
(43) Pub. Date: Feb. 3, 2011

(54) Crankshaft-free internal combustion engine of improved efficiency

(75) Inventor: Michael Inden, Belmont, CA (US)

Correspondence Address: MICHAEL INDEN, 2241 SEMERIA AVENUE, BELMONT, CA, 94002-1521, US

(73) Assignee: ALEXANDER KHAIMSKY

(21) Appl. No.: 12/462,315

(22) Filed: Aug. 3, 2009

(51) Int. Cl. F16C 7/00

(52) U.S. Cl. 123/197.3

(57) ABSTRACT

The crankshaft-free internal combustion engine which is of the type that contains at least one cylinder having a longitudinal axis, at least one piston that has a pivot pin and is slidingly installed in the cylinder, a main driveshaft having a central axis, which is offset at a distance from the longitudinal axis of the cylinder, and a cylindrical eccentric which is eccentrically and non-rotationally secured on the main drive shaft A distinguishing feature of the engine is a connecting rod that has a substantially L-shaped configuration formed by one portion which is substantially straight and is pivotally connected to the pivot pin of the cylinder and a second portion which is substantially transverse to the first portion and pivotally receives the cylindrical eccentric. The distance from the central axis of the main driveshaft to the longitudinal axis of the cylinder is always greater than 0. Such a construction significantly improves efficiency of the engine.

### TECHNICAL FIELD

The present invention relates to internal combustion engines. More specifically, the present invention relates to a crankshaft-free internal combustion engine, in particular to a crankshaft-free internal combustion engine having an improved design of a driveshaft and engine assembly.

### BACKGROUND OF THE INVENTION

Internal combustion engines are any of a group of devices in which the reactant of combustion, e.g., oxidizer and fuel, and the products of combustion serve as the working fluids of the engine. Internal combustion (IC) engines can be categorized into spark ignition (SI) and compression ignition (CI) categories. SI engines, i.e. typical gasoline engines, use a spark to ignite the air-fuel mixture, while the heat of compression ignites the air-fuel mixture in CI engines, i.e., typically diesel engines. The basic concept of the design of both a typical gasoline engine and a diesel engine has not changed for more than 100 years.

The basic components of an internal combustion engine are well known in the art and include the engine block, cylinders, pistons, valve, crankshaft and camshaft. Such an engine gains its energy from the heat released during the combustion of the non-reacted working fluids, e.g., the oxidizer-fuel mixture. In all internal combustion engines, useful work is generated from the hot, gaseous products of combustion acting directly on moving surfaces of the engine, such as the top or crown of a piston.

Referring to FIG. 1, an exemplary embodiment of a prior art conventional internal combustion engine is shown at 20. The engine 20 includes an engine block 22 having the cylinder 24 extending therethrough. The cylinder 24 is sized to receive the reciprocating piston 26 therein. Attached to the top of the cylinder 24 is the cylinder head 28, which includes an inlet valve 30 and an outlet valve 32. The bottom of the cylinder head 28, cylinder 24 and top (or crown 34) of the piston 26 form a combustion chamber 36 chambers into which fuel and oxidizer (e.g. air) are introduced, and combustion takes place. A connecting rod 38 is pivotally attached at its top distal end 40 to the piston 26. A crankshaft 42 includes a mechanical offset portion—the crankshaft throw 44, which is pivotally attached to the bottom distal end 46 of connecting rod 38. The mechanical linkage of the connecting rod 38 to the piston 26 and crankshaft throw 44 serves to convert the reciprocating motion (as indicated by arrow 48) of the piston 26 to the rotary motion (as indicated by arrow 50) of the crankshaft 42. The crankshaft 42 is mechanically linked (not shown) to 35 an inlet camshaft 52 and an outlet camshaft 54, which precisely control the opening and closing of the inlet valve 30 and outlet valve 32 respectively. The cylinder 24 has a longitudinal centerline (piston-cylinder axis) 56, which is also the centerline of reciprocation of the piston 26. The crankshaft 48 has a center of rotation (crankshaft axis) 58. The center of rotation 58 of the crankshaft 48 substantially coincides with the centerline 56 of the cylinder and reciprocation of the piston 26.

The crank-connecting rod system was first fully developed back in the 12^{th} century. Referring to FIG. 2, a crankshaft 60 contains two or more centrally located coaxial cylindrical or “main” journals 62 and one or more offset cylindrical crankpin or “rod” journals 64. The crankshaft main journals rotate in a set of supporting main bearings, causing the offset rod journals or throw 66 to rotate in a circular path around the main journal centers, the diameter of which is twice the offset of the rod journals. The diameter of that path is equal to the distance the piston moves up and down in its cylinder, which is called a “stroke”.

Referring to FIG. 3, an alternative to the above-described conventional crankshaft is a crankshaft-free driveshaft and piston assembly. This apparatus is disclosed generally in pending U.S. patent application Ser. No. 12/151,954 to Michael Inden, filed on May 12, 2008, titled Crankshaft-Free Drive Shaft and Piston Assembly of a Split-Cycle Four-Stroke Engine, which is herein incorporated by reference in its entirety. The apparatus 70 (for simplicity of the drawing and description the cylinder block of an engine and other engine components are not shown) is a driveshaft and piston assembly that comprises a rotary driveshaft 72 (hereinafter referred to merely as “a shaft”) of a square cross-section which includes a circular eccentric 74 mounted in its indexed position and a pair of integrally mounted cylindrical bushings 76a and 76b. The shaft 72 is journaled at the bushings 76a and 76b for rotation about a shaft axis 78. A connecting rod 80 is pivotally connected to both the circular eccentric 74 of the shaft 72 and a piston 82 at its top distal end. The mechanical linkage of the connecting rod 80 to the piston 82 and the circular eccentric 74 which is indexed on the shaft 72 serves to convert the reciprocating motion of the piston (as indicated by directional arrow A for the piston 82) to the rotational motion (as indicated by directional arrow C) of the shaft 72. The cylindrical bushings 76a and 76b have a coaxial opening of substantially the same cross-section as a cross-section of the shaft 72 of FIG. 3.

Though this embodiment of the invention shows cross-sections of the shaft 72 and opening of the circular eccentric 74 as substantially square, it is within the scope of this invention that other cross-sections may also be employed, such as other polygons with different numbers of sides, ellipses, or others which will assure an indexed position of the circular eccentric 74 on the shaft 72.

In an alternative exemplary modification of the invention 86, illustrated in FIG. 4, a connecting rod 88 may be positioned tangentially to the circular eccentric 74 in order to maximize torque applied to the shaft 72 during the power stroke.

FIGS. 5 and 6, which are schematic diagrams of an exemplary embodiment of two circular eccentrics 90 and 92, illustrate how orientation of openings 94 and 96 for mounting circular eccentrics on a shaft provides indexing of the circular eccentrics on the shaft. FIG. 5 illustrates the circular eccentric 90 which has an opening 94 of substantially the same cross-section as a cross-section of the shaft 72, positioned at a distance “E1” from the center of the circular disk 90. The opening 96 of the substantially same cross-section positioned at a distance “E2” from the center of the circular disk 92 in FIG. 6 is turned at an angle “G” with respect to the position of the opening 94 of the circular eccentric 90 of FIG. 5. Because in a four-stroke cycle engine, a four stroke cycle is completed in two revolutions of a shaft, the second index angle is equal to 720 degrees divided by the number of pistons in an engine and so on. Because in a two-stroke cycle diesel engine, a stroke cycle is completed during one revolution of a shaft, the second indexed angle is equal to 360 degrees divided by the number of pistons in an engine. The distances “E1” of FIG. 5 and “E2” of FIG. 6 as well as diameters of circular eccentrics 90 of FIG. 5 and 92 of FIG. 6 can be the same or differ.

Output power of an engine is defined as a product of torque, speed of rotation of a shaft and units' conversion coefficient. The magnitude of a torque depends on a force applied and a moment arm, which is a distance from the axis of rotation to the direction of the force application. The length of the moment arm is particularly important In cases involving an internal combustion engine with a crankshaft, the offset rod journal or throw of the crankshaft rotates in a circular path around the main journal center and moves the bottom distal end of the connecting rod from one side of the centerline of the cylinder to another. Thus, during a power stroke when combustion is tading place in the combustion chamber of the cylinder, the length of the moment arm fluctuates from 0 to the length of the crankshaft throw and back to 0, causing significant fluctuation of the torque. All of this leaves little room for an engineer to influence the output power.

Many rather exotic early engine designs were patented. Examples of these early patents include U.S. Pat. No. 2,091,413 of 1937 and U.S. Pat. No. 2,269,948 of 1942, both issued to M. Mallory. Various other relatively recent specialized prior art engines have also been designed in an attempt to increase engine efficiency, such as U.S. Pat. Nos. 5,546,897 issued in 1996 to D. Brackett, U.S. Pat. No. 5,623,894 issued in 1997 to J. Clarke, and U.S. Pat. No. 6,058,901 issued in 2000 to C. L. Lee. However, none were able to offer greater efficiencies or other significant advantages which would replace the standard engine.

Accordingly, there is a need to increase the torque generated during a power stroke of an internal combustion engine and reduce fluctuation of the torque and thus increase power output of an engine or decrease fuel consumption for desired power output of the engine.

### SUMMARY OF THE INVENTION

It is an object of this invention to provide means which will reduce the relationship between a piston stroke of an internal combustion engine and a torque induced on a driveshaft of the engine in a power stroke.

It is another object of the invention to provide a crankshaft-free internal combustion engine with an increased torque on a driveshaft of the engine.

It is yet another object of this invention to provide a crankshaft-free internal combustion engine with increased fuel efficiency for the required engine power output.

It is another object of the invention to provide a crankshaft-free internal combustion engine which is simple in design and inexpensive to manufacture.

The crankshaft-free internal combustion engine of the present invention is of the type that contains at least one cylinder having a longitudinal axis, at least one piston that has a pivot pin and is slidingly installed in the cylinder, a main driveshaft having a central axis, which is offset at a distance from the longitudinal axis of the cylinder, and a cylindrical eccentric which is eccentrically and non-rotationally secured on the main drive shaft. A distinguishing feature of the engine is a connecting rod that has a substantially L-shaped configuration formed by one portion that is substantially straight and is pivotally connected to the pivot pin of the cylinder and a second portion which is substantially transverse to the first portion and pivotally receives the cylindrical eccentric. The distance from the central axis of the main driveshaft and the longitudinal axis of the cylinder is always greater than 0. Such a construction significantly improves efficiency of the engine.

The above features and advantages of the present invention will be apparent from or are set forth in more detail in the accompanying drawings, which are incorporated in and form a part of this specification, and the following Detailed Description of the Invention, which together serve to explain by way of example the principles of the present invention.

### BRIEF DESCRIPTION OF THE DRAWING

FIG. 1 is a schematic diagram of a representative prior art conventional four stroke internal combustion engine.

FIG. 2 is a schematic diagram of an exemplary embodiment of the prior art crankshaft of an internal combustion engine.

FIG. 3 is a schematic diagram of an exemplary embodiment of the apparatus of the prior art crankshaft-free driveshaft and piston assembly of an internal combustion engine.

FIG. 4 is a schematic diagram of an exemplary embodiment of an apparatus of the prior art crankshaft-free driveshaft and piston assembly of an internal combustion engine with an alternative embodiment of the connecting rod.

FIG. 5 is a schematic diagram of a prior art cylindrical eccentric in the first indexed position of an internal combustion engine.

FIG. 6 is a schematic diagram of a prior art cylindrical eccentric in the second indexed position of an internal combustion engine.

FIG. 7 is a schematic diagram of an exemplary embodiment of a connecting rod of the prior art crankshaft-free driveshaft and piston assembly of a split-cycle four-stroke.

FIG. 8 is a schematic diagram of an exemplary embodiment of a connecting rod of the present invention.

FIG. 9 is a schematic diagram of an exemplary embodiment of an apparatus of the present invention.

FIG. 10 is a schematic diagram of an exemplary embodiment of an inline engine of the present invention.

FIG. 11 is a schematic diagram of an exemplary embodiment of a U-engine of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION OF THE PREFERRED EMBODIMENTS

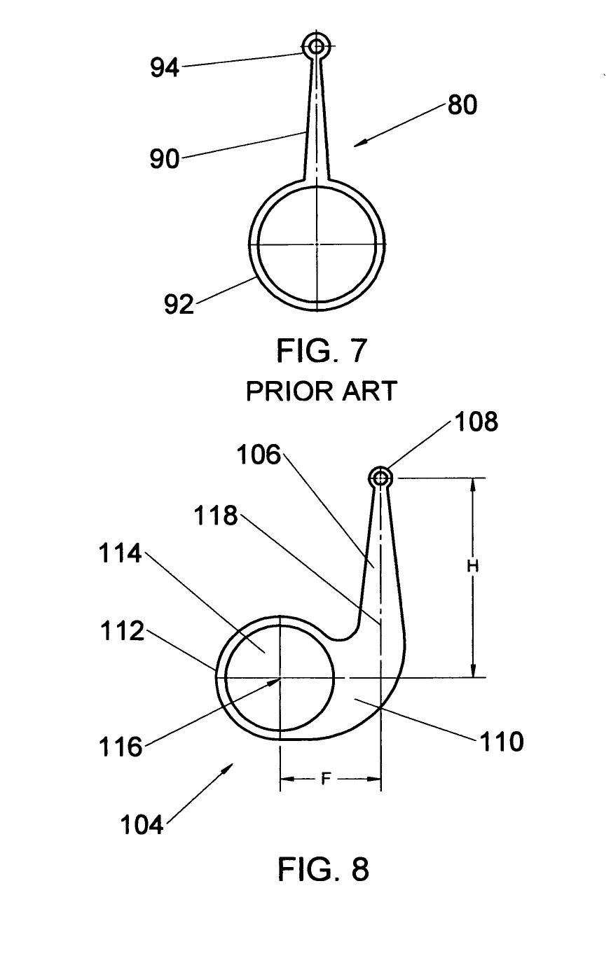

For better understanding the distinguishing features of the present invention, it would be appropriate to again refer to the structure of a connecting rod used in an internal combustion engine which was disclosed in U.S. patent application Ser. No. 12/151,954 filed earlier by the same applicant and the improvement of which the present application is aimed. More specifically, FIG. 7 illustrates an exemplary embodiment of a connecting rod 80 of a crankshaft-free driveshaft and piston assembly of a split-cycle four-stroke engine. The connecting rod 80 comprises a straight arm 90 connecting a small distal end 94 for attachment to a piston pin (not shown in FIG. 7) and a big end 92 for pivotally connecting to a circular eccentric (not shown in FIG. 7). In a mechanism with this type of a connecting rod, piston stroke and engine torque are defined only by features of a circular eccentric, such as eccentric diameter and eccentricity.

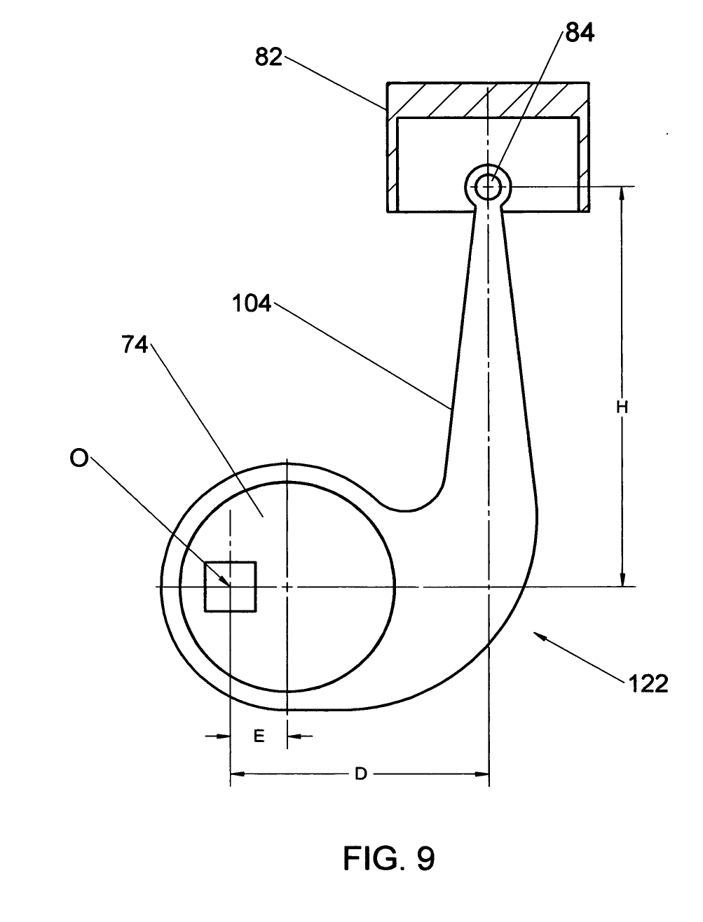

An example of a connecting rod 96 of the present invention is shown in FIG. 8. FIG. 9 is a schematic diagram of an exemplary embodiment of the device of present invention. As can be seen from FIGS. 8 and 9, the straight connecting rod 90 of the prior art is replaced by a substantially L-shaped connecting rod 104 having a straight portion 106, connected to a small distal end 108 for attachment to a piston pin 84, and a transverse portion 110 with the big end 112 for pivotally connecting to a circular eccentric 74 (FIG. 9). The big end 110 has an opening 114 in which the circular eccentric 74 is pivotally installed for realization of the aforementioned pivotal connection of the circular eccentric 74 to the connecting rod 104.

Letter O designates the center of rotation of the circular eccentric 74. Length of the transverse portion 110 is indicated by letter F as a distance between the center 116 of the opening 114 for the circular eccentric 74 (FIG. 9) and a longitudinal axis 118 of the connecting rod 104. Distance F is defined by design requirements. Height of the straight portion 106 is indicated by letter H as a vertical distance between the big end 110 and the small end 108. This parameter is defined by design requirements as well. If needed, the connecting rod 104 can have a counterbalance where needed in a proper position on the big end 110.

In FIG. 9 the entire assembly, which as a whole is designated by reference numeral 122, comprises the piston 82, the circular eccentric 74, and the connecting rod 104. This assembly serves to convert the reciprocating motion of the piston 82 to the rotational motion of the shaft. It can be seen from FIG. 9 that in the position shown in FIG. 9 the value of the moment arm D between the piston 82 and the center of rotation “O” is equal to the sum of eccentricity E of the eccentric 74 and length F of the transverse portion 110 of the connecting rod 104. It is easily understood that both the eccentricity E of the eccentric 74 and length F of the transverse portion 110 can be changed independently, and thus the value of the moment arm D and piston stroke will change independently as well.

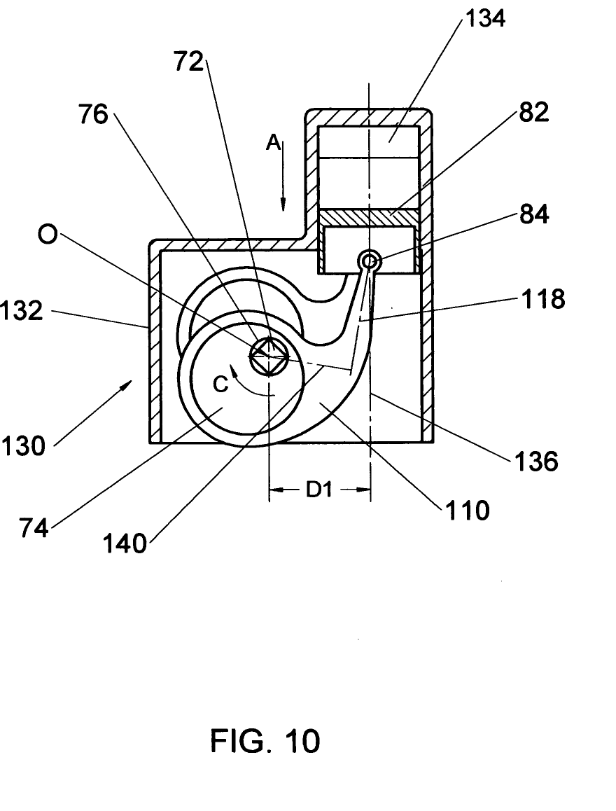

An exemplary embodiment of the driveshaft and piston assembly of the present invention placed in an L-block of an engine 130 is shown generally in FIG. 10. Distance D1 between the center of the driveshaft 72 and the centerline 136 of a cylinder bore 134 and a value of a moment arm D in FIG. 9 can vary in order to influence the resulting value of the moment arm. The stroke of the piston 82 is defined mainly by eccentricity E of the circular eccentric 74 and in a lesser degree by the length F of the transverse portion 110 at the same height H of the straight portion 106 of the connecting rod 104. In this exemplary embodiment rotating force is acting along the longitudinal axis 118 of the connecting rod 104. The moment arm of this rotating force is a distance 140 from the axis of rotation “O” to the direction of the force application. During the power stroke, when combustion is taking place in the combustion chamber of the cylinder, the longitudinal axis 118 of the connecting rod 104 never passes through the axis of rotation “O”. Thus, even though the length of this moment arm fluctuates, it never becomes 0 and does not cause significant fluctuation of the torque.

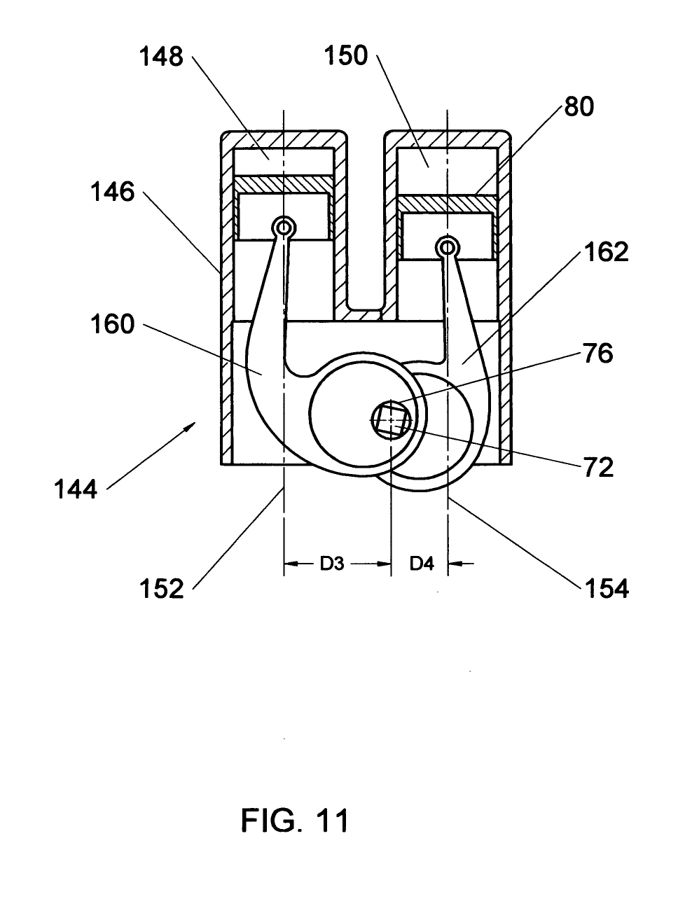

Another exemplary embodiment of the driveshaft and piston assembly of the present invention placed in a U-block of an engine 144 is shown generally in FIG. 11. This particular embodiment of the current invention comprises an engine block 146 with two parallel banks of cylinders 148 and 150, the driveshaft 72 with at least a pair of integrally mounted cylindrical bushings 76 and at least one pair of sub-assemblies 122, wherein each sub-assembly is comprised of a circular eccentric, such as the circular eccentric 74 mounted on the rotary driveshaft 72, the piston 80 and connecting rod 104 pivotally connected to the circular eccentric 74 and to the piston 80. The circular eccentric 74 is angularly indexed according the power cycles sequence with respect to other eccentrics on the aforementioned rotary driveshaft 72. As shown in FIG. 11, the sub-assemblies used in separate the banks of cylinders can be slightly different. For examples, they may have different connecting rods 160 and 162 the design of which is selected for achieving the most optimal performance of the engine. In the embodiment shown in FIG. 11 distance D3 between the center of the driveshaft 72 and the centerline 152 of a cylinder bore 148 and distance D4 between the center of the driveshaft 72 and the centerline 154 of a cylinder bore 150 are different.

Neither inlet and outlet valves nor corresponding camshafts and spark plugs are shown in FIGS. 10 and 11 because they are not affected in any way by the current invention.

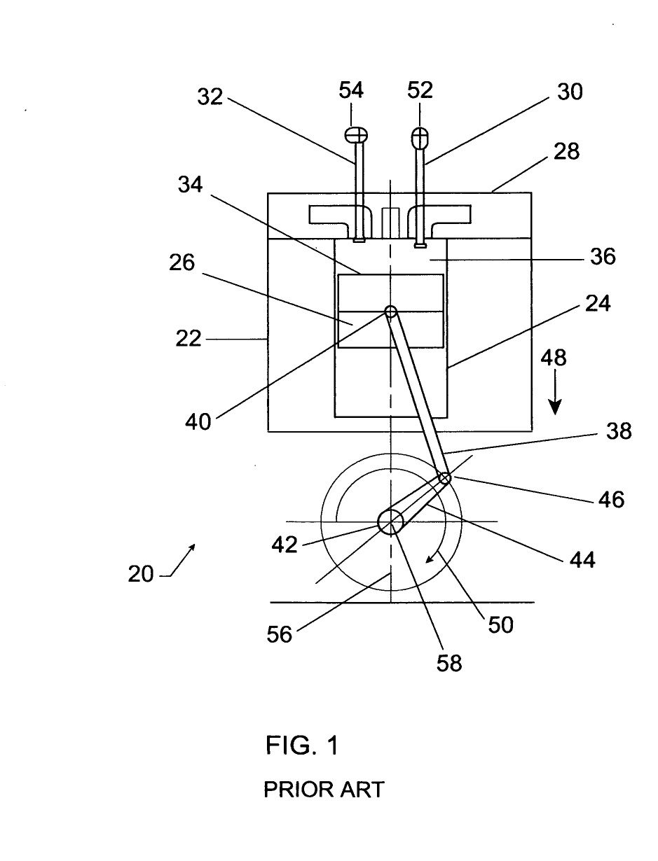

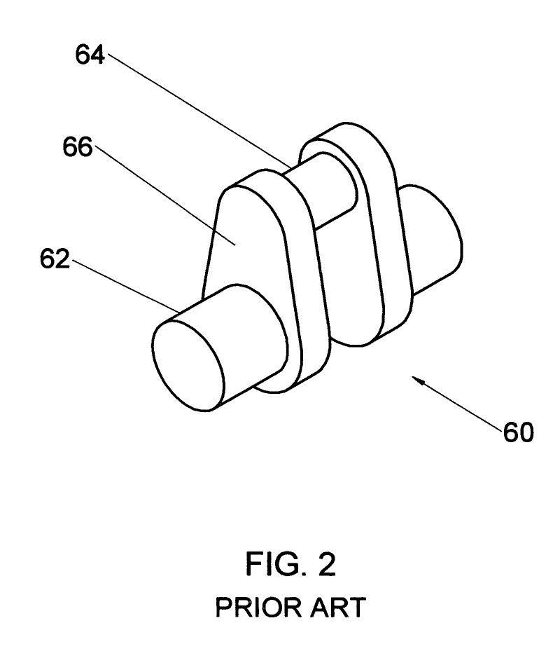

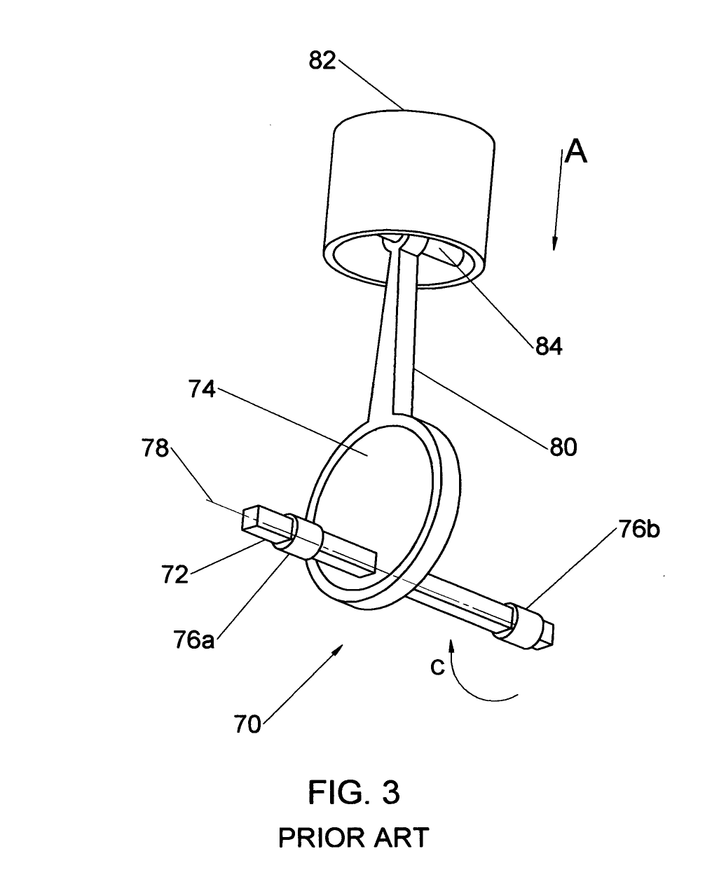

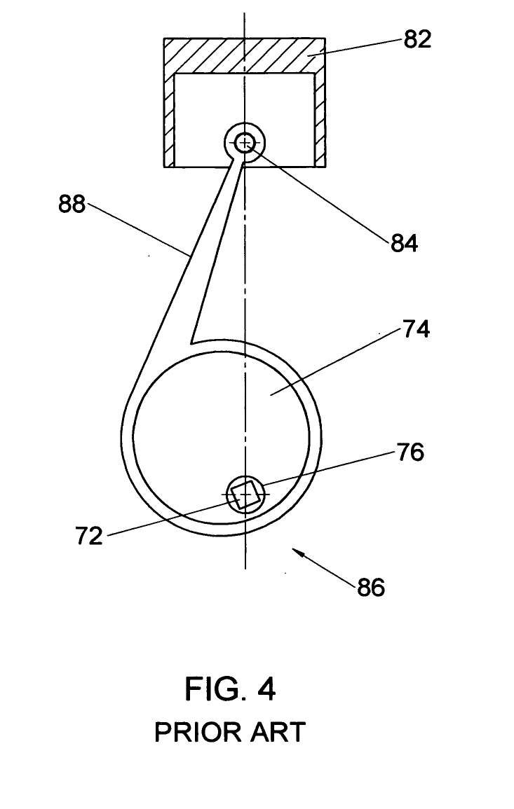

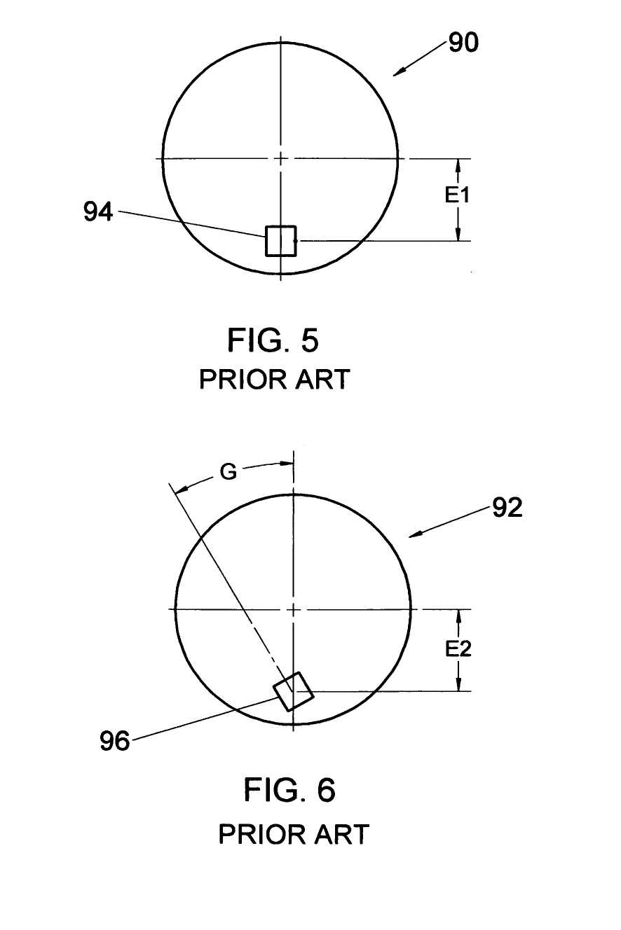

A method of the invention for increasing the torque on the output shaft and/or for reducing the fuel consumption of the engine comprises replacing a crankshaft of a conventional internal combustion engine of the type shown in FIGS. 1 and 2 with the device of the present invention that contains the above-described L-shaped connecting rod that consists of the straight portion 106 and the transverse portion 110 with the length F of the transverse portion 110 that allows torque to stay always above 0.

During the operation, the power piston 82 (FIG. 10) moves linearly in the directions of arrow A and converts by means of the L-shaped connecting rod 104 its reciprocating motion to rotational motion of the circular eccentric 74 (as indicated by directional arrow C) which results in rotation of the shaft 72. As shaft 72 rotates in the direction of arrow C, it turns the circular eccentric 74 which translates into linear reciprocating movements of other pistons of the engine.

Thus, it has been shown that the apparatus of the invention performs its functions substantially in the same way as a conventional crankshaft type. In other words, the apparatus of the invention provides an alternative to a conventional crankshaft for an internal combustion engine that is simple in design, less expensive, and easier to manufacture and balance. By extending a moment arm of a force, produced during fuel combustion, this apparatus will deliver torque for the required power of an internal combustion engine using less fuel. On the other hand, at the same fuel consumption this apparatus will increase torque and power of the engine if and when needed. This particular apparatus of the current invention will allow building an internal combustion engine with two parallel banks of cylinders, i.e., an U-engine which is simpler in design, less expensive and easier to manufacture than a V-engine. The apparatus will allow unrestricted number of cylinders for a four-stroke or two-stroke internal combustion engine. The apparatus allows replacement of journal bearings of a crankshaft by roller and/or needle bearings and, as a result, reducing heat generation in an engine and thus extending engine life span.

While preferred embodiments have been shown and described, various modifications and substitutions may be made thereto without departing from the spirit and scope of the invention. For example, though this embodiment describes a shaft as having a polygon or elliptical cross-section for indexing the circular eccentrics, one skilled in the art would recognize that there might be other means to index the circular eccentrics on the shaft as well. One skilled in the art would also recognize that more than a pair of bushings, which shown and described, can be employed on the shaft for additional bearing supports and/or positioning of the circular eccentrics. Even though this embodiment describes the apparatus as applied for an internal combustion engine, one skilled in the art would recognize that compressors are within the scope of this invention also. Accordingly, it is to be understood that the present invention has been described by way of illustration and not limitation.

What I claim is:

1. A crankshaft-free internal combustion engine of improved efficiency comprising:
at least one cylinder, the cylinder having a longitudinal axis;
at least one piston slidingly installed in the cylinder, the piston having a pivot pin;
a main driveshaft having a central axis, which is offset at a distance from the longitudinal axis of the cylinder,
a cylindrical eccentric which is eccentrically and non-rotationally secured on the main drive shaft;
a connecting rod having a first portion which is substantially straight and a second portion being pivotally attached which is substantially transverse to the first portion, the first portion of the connecting rod to the pivot pin of the piston, and the second portion of the connecting rod having a cylindrical opening that pivotally receives the cylindrical eccentric.

2. The crankshaft-free internal combustion engine of claim 1, wherein the first portion and the second portion form a substantially L-shaped configuration.

3. The crankshaft-free internal combustion engine of claim 1, wherein the distance at which the central axis of the main driveshaft is offset from the longitudinal axis of the cylinder and is always greater than zero.

4. The crankshaft-free internal combustion engine of claim 3, wherein the first portion and the second portion form a substantially L-shaped configuration.

5. The crankshaft-free internal combustion engine of claim 1, wherein the engine is selected from the group consisting of an L-type engine and a U-type engine.

6. The crankshaft-free internal combustion engine of claim 5, wherein the first portion and the second portion form a substantially L-shaped configuration.

7. The crankshaft-free internal combustion engine of claim 6, wherein the distance at which the central axis of the main driveshaft is offset from the longitudinal axis of the cylinder is always greater than zero.

8. A crankshaft-free internal combustion engine of improved efficiency comprising:
an engine block with parallel banks of cylinders, each cylinder having a longitudinal axis;
a piston slidingly installed in each cylinder, the piston having a pivot pin;
a main driveshaft common for the cylinders, the main shaft having a central axis, which is offset at a distance from the longitudinal axis of each cylinder;
a plurality of circular eccentrics, each cylindrical eccentric being associated with one of the pistons and being eccentrically and non-rotationally secured on the main drive shaft; and
a plurality of connecting rods, each connecting rod being associated with one of the cylinders and having a first portion which is substantially straight and a second portion which is substantially transverse to the first portion, the first portion of the connecting rod being pivotally attached to the pivot pin of the piston of the respective cylinder, and the second portion of the connecting rod having a cylindrical opening that pivotally receives the respective cylindrical eccentric.

9. The crankshaft-free internal combustion engine of claim 8, wherein the first portion and the second portion of each connecting rod form a substantially L-shaped configuration.

10. The crankshaft-free internal combustion engine of claim 8, wherein the distance at which the central axis of the main driveshaft is offset from the longitudinal axis of each cylinder is always greater than zero.

11. The crankshaft-free internal combustion engine of claim 10, wherein the first portion and the second portion of each connecting rod form a substantially L-shaped configuration.

12. The crankshaft-free internal combustion engine of claim 8, wherein the engine is selected from the group consisting of an L-type engine and a U-type engine.

13. The crankshaft-free internal combustion engine of claim 12, wherein the first portion and the second portion form a substantially L-shaped configuration.

14. The crankshaft-free internal combustion engine of claim 13, wherein the distance at which the central axis of the main driveshaft is offset from the longitudinal axis of the cylinder is always greater than zero.

15. A method for improving efficiency of an internal combustion engine comprising: at least one cylinder with a longitudinal axis, a piston slidingly installed in the cylinder along the longitudinal axis, the piston having a pivot pin; a main driveshaft having a central axis; a cylindrical eccentric, which is eccentrically and non-rotationally secured on the main drive shaft; and a connecting rod having one end pivotally connected to the pivot pin and the other end pivotally receiving the circular eccentric; the method comprising the steps of:
offsetting the central axis of the main driveshaft at a distance from the longitudinal axis of the cylinder; and
arranging said one end of the connecting rod substantially transverse to said other end of the connecting rod.

16. The method of claim 15, further comprising the step of arranging said one end and said other end so that the connecting rod acquires a substantially L-shaped configuration.

17. The method of claim 15, wherein the distance from the longitudinal axis of the cylinder is greater than zero.

18. The method of claim 17, further comprising the step of arranging said one end and said other end so that the connecting rod acquires a substantially L-shaped configuration.
